(19) United States
(12) Patent Application Publication
(10) Pub. No.: US 2008/0047464 A1
(43) Pub. Date: Feb. 28, 2008

(54) AQUEOUS RELEASE AGENTS AND THEIR USE IN THE PRODUCTION OF POLYURETHANE MOLDINGS

(75) Inventor: Torsten Henning, Schwerin (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/843,832

(22) Filed: Aug. 23, 2007

(30) Foreign Application Priority Data
Aug. 25, 2006 (DE) 10 2006 040 009.7

(51) Int. Cl. C09D 4/00

(52) U.S. Cl. 106/38.25; 106/38.22

(57) ABSTRACT

The invention provides aqueous release agent dispersions for producing polyurethane moldings, substantially comprising
A) at least one agent having release activity, from the group consisting of soaps, oils, waxes and silicones, and
B) emulsifiers and
C) if desired, foam stabilizers, and
D) if desired, viscosity modifiers, and
E) if desired, auxiliaries and additives, and
F) at least one bismuth carboxylate, and
G) water.

This application claims benefit under 35 U.S.C. 119(a) of German patent application DE 10 2006 040 009.7, filed on Aug. 25, 2006

The invention relates to aqueous release agents and to their use in the production of polyurethane moldings.

It is known that the polyurethane systems used for producing moldings exhibit strong adhesion to the mold materials that are used, preferably highly thermally conductive materials such as metals. For the demolding of the polyurethane moldings, therefore, there is a need for release agents, which are applied to the mold walls that come into contact with polyurethanes and/or with the polyurethane reaction mixture.

Release agents of this kind are composed of dispersions or emulsions of waxes, soaps, oils and/or silicones in solvents such as hydrocarbons or water.

Following application of the release agent to the mold, the solvent evaporates and the non-volatile substances with release activity form a thin release film which is intended to ensure that the polyurethane molding can be removed easily from the mold after it has been produced.

In order to reduce the burden of organic material on the environment, there is a high level of interest in release agents on an aqueous basis that are free from volatile organic material. However, the aqueous release agents that are on the market have the disadvantage as compared with conventional release agents, those containing organic solvents, that, following the evaporation of a major part of the water, there is always still a thin water film left in the mold, which does not undergo volatilization at the typical mold temperatures of 45° C. to 80° C., preferably 50° C. to 75° C., and enters into reactions with the isocyanate compounds of the polyurethane system, those reactions leading to very hard and rigid polyurea compounds. As a result, the mold surfaces are adversely affected. They acquire a so-called build-up, which must be removed by laborious cleaning.

In addition to the release effect that is actually needed, the release agent also takes on further functions. For instance, it also very greatly influences the surface of the polyurethane molding, which is to be fine-pored or smooth and uniform, for the purpose, among others, of ensuring that the finished moldings can be readily, i.e. easily, covered with fabrics or leather.

In the course of ever greater optimization of production rates, in particular in the automobile supplier industry, it is precisely the above-described property of the coverability of the polyurethane molding that has become an important quality feature.

One option of improving the surface quality of the polyurethane foam moldings is to use substances which catalyze and thereby accelerate the polyol-isocyanate reaction. The commercial aqueous release agents for polyurethane moldings therefore typically include what are called tin accelerants, in other words catalysts based on organotin compounds. As well as improving the surface quality, these tin accelerants also have a release assist effect, since they accelerate the polyol-isocyanate reaction at the interface between foam and release film.

Also alleviated thereby is the above-described problem of mold build-up, since as a result of the release assist effect of the tin accelerator it is not necessary to apply so much release agent to the mold in order to achieve effective release.

Particularly suitable are di-n-butyltin dicarboxylates, as described in EP 1 082 202. Principally dibutyltin dilaurate (DBTL) is used, as described for example in DE 35 41 513 or DE 34 10 219.

As is known, DBTL is labeled R 50/53 (dangerous for the environment, very toxic to aquatic organisms) and harbors risks to the environment during storage and transport of release agents which contain DBTL.

Consequently, many polyurethane foam molding customers, in the footwear sole or mattress sector, for example, are already demanding that the release agent used be free from tin compounds.

Moreover, the ECB (European Chemical Bureau) is undertaking a categorization which labels organotin compounds as reproductive toxins, with the R phrases R60—R61. This will affect certain di-n-butyltin dicarboxylates, among them DBTL. In that case it will be virtually impossible to use release agents including such components any longer.

It was the object of the present invention, therefore, to find aqueous mold release agents which are free from organotin compounds and yet exhibit an effective release action, do not cause any build-up on the mold walls and favorably influence the surfaces of the polyurethane moldings, in other words leaving them fine-pored, smooth and uniform.

Surprisingly it has been found that the use of bismuth salts of organic acids as catalysts in amounts of 0.1% to 10% by weight, preferably 0.5% to 5% by weight, in particular 0.5% to 3% by weight, in aqueous dispersions comprising conventional, release-active substances such as waxes, soaps, oils and/or silicones in amounts of 0.5% to 40% by weight, preferably 3% to 20% by weight, fulfils this object.

The invention accordingly provides aqueous release agent dispersions for producing polyurethane moldings, substantially comprising:
A) at least one agent having release activity, from the group consisting of soaps, oils, waxes and silicones, and
B) emulsifiers and
C) if desired, foam stabilizers, and
D) if desired, viscosity modifiers, and
E) if desired, auxiliaries and additives, and
F) 0.1% to 10% by weight, preferably 0.5% to 5% by weight, of at least one bismuth carboxylate, and
G) water.

The dispersions are preferably composed of:
A) 0.5% to 40% by weight of at least one agent having release activity, selected from the group consisting of soaps, oils, waxes, and silicones and
B) 0.1% to 10% by weight of emulsifiers,
C) 0% to 5% by weight of foam stabilizers,
D) 0% to 5% by weight of viscosity modifiers,
E) 0% to 2% by weight of typical preservatives, bactericides, fungicides, and antioxidants,
F) 0.1% to 10% by weight, preferably 0.5% to 5% by weight, of at least one bismuth carboxylate, and
G) water.

As bismuth carboxylates it is preferred to use Bi(III) salts of organic acids R—COOH, where R is an unbranched or branched C₆ to C₂₂ hydrocarbon radical optionally containing multiple bonds, i.e., alkyl radical, alkenyl radical and/or aryl radical.

Organic acids preferably used are the monobasic fatty acids that are customary and known in this field and are based on natural vegetable or animal fats and oils having 6 to 22 carbon atoms, preferably having >=8 to 20 C atoms, in particular having 8 to 18 carbon atoms, such as caproic acid, caprylic acid, 2-ethylhexanoic acid, capric acid, neodecanoic acid, lauric acid, myristic acid, palmitic acid, palmitoleic acid, isostearic acid, stearic acid, oleic acid, linoleic acid, petroselinic acid, elaidic acid, arachidic acid, behenic acid, erucic acid, gadoleic acid, rapeseed oil fatty acid, soybean oil fatty acid, sunflower oil fatty acid, tall oil fatty acid, and also the technical mixtures obtained in the course of pressurized cleavage. In principle, all fatty acids with similar chain distribution are suitable.

The unsaturated components content of these fatty acids is adjusted—if necessary—to a desired iodine number by means of the known catalytic hydrogenation processes or is achieved by blending fully hydrogenated with unhydrogenated fatty components.

The iodine number, as a numerical measure of the average degree of saturation of a fatty acid, is the amount of iodine absorbed by 100 g of the compound for the saturation of the double bonds.

The bismuth carboxylates can be prepared from Bi(III) compounds with the organic acids R—COOH by the processes known from the literature or are available as commercial products under the respective brand names, such as bismuth trioctoate or bismuth trineodecanoate, under the brand names for example of Borchi® Kat (Borchers GmbH) or Tegokat® (Goldschmidt TIB GmbH), Neobi® 200, from Shepherd, and Coscat®, from Caschem. These substances are not classed as toxic and are not classed as dangerous for the environment.

These salts on the one hand catalyze the reaction of the polyols with the isocyanates at the interfaces of the reaction mixture/mold surface, and additionally influence the surface quality of the foam in the direction of the required cell sizes and structure: the latter should lie within a certain cell size (fine-celled, but no microfoam or coarse foam) and should be slightly open-pored (not closed or predominantly open). These criteria are largely practical, i.e., can be optimized by means of a few range finding tests, and make it easier to cover the molding with, for example, textile coverings.

The invention further provides for the use of these dispersions as external release agents in the production of polyurethane moldings.

Further subjects of the invention are characterized by the claims.

As conventional substances with release activity it is possible in accordance with the invention to make use for example of:

waxes, i.e., liquid, solid, natural or synthetic waxes, also oxidized and/or partly hydrolyzed;
esters of carboxylic acids with alcohols or fatty alcohols,
metal soaps, such as alkali metal or alkaline earth metal salts of fatty acids;
oils, such as hydrocarbons which are viscous or liquid at room temperature, if desired—but not preferably—used with unsaturated oligomeric and/or polymeric hydrocarbons;
silicones, such as polydimethylsiloxanes, substituted if desired by aliphatic or aromatic hydrocarbon radicals.

Typical waxes having release activity are set out for example in the company brochures “Waxes by Clariant, production, characteristics and applications”, Clariant, May 2003, and “Formtrennmittel mit Vestowax®” from Degussa.

Typical emulsifiers that can be used may be one or more compounds selected from the following groups:
I) anionic emulsifiers such as
   alkyl ether carboxylates, alkyl sulfates, fatty alcohol ethoxylated ether sulfates, alpha-olefin-sulfonates, alkyl phosphates, alkyl polyether phosphates, alkylsulfosuccinates, nonionic emulsifiers such as ethoxylated fatty alcohols, ethoxylated oxo-process alcohols, and other alcohol ethers, fatty amines such as dimethyl-alkylamines, fatty acid alkanol amides, fatty acid esters with alcohols, including glycerol esters or polyglycerol esters or sorbitol esters,
II) cationic emulsifiers such as
   acidified alkyldimethylamines, quaternary nitrogen compounds,
III) zwitterionic surfactants,
   in amounts of 0.1% to 10% by weight, preferably 0.5% to 6% by weight.

As typical auxiliaries and additives it is possible to use jointly one or more of the compounds that are known in the prior art, for example selected from the group consisting of polyurethane foam stabilizers, such as polysiloxane-polyether copolymers, and also typical viscosity modifiers such as typical thickeners, for instance polyacrylic acid derivatives referred to as carbomers, or other polyelectrolyte thickeners such as water-soluble cellulose derivatives or else xanthan gum. Aliphatic hydrocarbons as well can be regarded as being viscosity modified in aqueous formulations—these hydrocarbons thus being petroleum fractions which swell the waxes that are employed and which, as a result, exhibit a thickening effect; typical preservatives, bactericides, fungicides, and antioxidants.

The dispersions of the invention can be prepared by the processes known in the prior art. A preferred procedure is initially to charge the emulsifier with substances with release activity, in a melted form (below the boiling temperature of water), to introduce part of the water under a high shearing force, and then to add the remaining water, containing the further components, under a low shearing force.

Conventionally the mold is brought to the desired mold temperature of 45 to 80° C., preferably 50 to 75° C., and is sprayed with release agent, a certain time—depending on the proportion of water about 1 to 10 minutes—is allowed to pass until the majority of the water has evaporated, and then the reactive polyurethane system comprising polyols, polyisocyanates, and, if desired, further additives such as catalysts, foam stabilizers, and blowing agents, is pumped in. The mold is closed and, after the cure time, is opened and the molding is removed.

### EXAMPLES

The examples which follow serve the more detailed description of the invention, but do not restrict it to them.

### List of Substances Used:

DC® 190=polyethersiloxane, manufacturer: Air Products,
Polyöl® 130=polybutadiene with an average molar mass of about 3000 and an iodine number of about 450 g iodine/100 g, manufacturer: Degussa,
fatty amine=R—NH₂ with R═C₁₂₋₂₂, unbranched or branched alkyl radical,
microwax=commercial waxes having a solidification temperature of 50° C. to 90° C.,
polyethylene wax=commercial waxes having a solidification temperature of 50° C. to 90° C.,
Tegokat® bismuth(III) neodecanoate, manufacturer: Goldschmidt TIB GmbH
Kosmos® 19=dibutyltin dilaurate (DBTL), manufacturer: Goldschmidt GmbH
Desmophen® PU 50REII=polyetherpolyol, manufacturer: Bayer,
Tegoamin® TA 33, manufacturer: Goldschmidt GmbH
Tegostab® B 4113=organically modified siloxane, manufacturer: Goldschmidt GmbH,
Suprasec® X 2412=diphenylmethane 4,4′-diisocyanate, manufacturer: Huntsman.

### Example 1

### Release Agent 1, Without Catalyst

1.2% by weight of polyethylene wax (solification point 60° C.), 6.4% by weight of microwax (solidification point 70° C.), 6.0% by weight of Polyol® 130, 1.4% by weight of fatty amine, 0.1% by weight of acetic acid (60% in water), 1.5% by weight of DC® 190, 83.4% by weight of water.

### Example 2

### Release Agent 2, with DBTL

1.2% by weight of polyethylene wax (solidification point 60° C.), 6.4% by weight of microwax (solidification point 70° C.), 6.0% by weight of Polyol® 130, 1.4% by weight of fatty amine, 0.1% by weight of acetic acid (60% in water), 1.5% by weight of DC® 190, 0.4% by weight of Kosmos® 19, 83.0% by weight of water.

### Example 3

### Release Agent 3, with Bismuth(III) Neodecanoate

1.2% by weight of polyethylene wax (solification point 60° C.), 6.4% by weight of microwax (solidification point 70° C.), 6.0% by weight of Polyol® 130, 1.4% by weight of fatty amine, 0.1% by weight of acetic acid (60% in water), 1.5% by weight of DC® 190, 0.3% by weight of Tegokat® bismuth(III) neodecanoate, 83.1% by weight of water.

### Example 4

### Release Agent 4, with Bismuth(III) Neodecanoate

1.2% by weight of polyethylene wax (solidification point 60° C.), 6.4% by weight of microwax (solidification point 70° C.), 6.0% by weight of Polyöl® 130, 1.4% by weight of fatty amine, 0.1% by weight of acetic acid (60% in water), 1.5% by weight of DC® 190, 0.6% by weight of Tegokat® bismuth(III) neodecanoate, 82.8% by weight of water.

### Example 5

### Release Agent 5, with Bismuth(III) Octoate

1.2% by weight of polyethylene wax (solidification point 60° C.), 6.4% by weight of microwax (solidification point 70° C.), 6.0% by weight of Polyol® 130, 1.4% by weight of fatty amine, 0.1% by weight of acetic acid (60% in water), 1.5% by weight of DC® 190, 0.6% by weight of Tegokat® bismuth(III) octoate, 82.8% by weight of water.

### Release Agent Tests:

The release agents were applied by spraying using a 0.5 mm nozzle, in amounts of 20 g/m², similar to those used in practice, to metal test plates, and a foamable polyurethane system composed of 100 parts of Desmophen® PU 50REII, 3.5 parts of water, 0.5 part of Tegomin® TA 33, 1.5 parts of diethanolamine, 1 part of Tegostab® B4113, 78 parts of Suprasec® X 2412, was foamed onto these plates in a box mold at 48° C.

After curing had taken place (10 minutes), the metal plates were peeled from the foam using a spring force meter, in order to measure the extent of the release effect.

### Evaluation of the Release Tests:

| | Force for peeling | |
|---|---|---|
| Release | the metal plate | Assessment of the foam |
| agent | from the foam [kg] | surface |
| 1 | 1.1 | skin formation, smeary, |
| | | difficult to cover, since |
| | | excessive frictional |
| | | forces arise on the closed |
| | | and therefore relatively |
| | | large surface |
| 2 | 0.8 | slightly open-pored, dry |
| | | readily coverable |
| 3 | 0.8 | slightly to less open- |
| | | pored, satisfactorily to |
| | | readily coverable |
| 4 | 0.8 | slightly open-pored, dry, |
| | | readily coverable |
| 5 | 0.9 | slightly open-pored, dry, |
| | | readily coverable |

As is apparent from the table above, the non-toxic bismuth salts used in accordance with the invention fulfill the requirements in practice with regard to coverability and pore properties. They exhibit significant technical advantages over the control without catalyst (release agent 1) and are equal in technical effect to the toxic tin compounds (release agent 2).

We claim:

1. An aqueous release agent dispersion for producing polyurethane moldings, substantially comprising
A) at least one agent having release activity, from the group consisting of soaps, oils, waxes and silicones, and
B) emulsifiers and
C) if desired, foam stabilizers, and
D) if desired, viscosity modifiers, and
E) if desired, auxiliaries and additives, and
F) 0.1% to 10% by weight of at least one bismuth carboxylate, and
G) water.

2. The aqueous release agent dispersion for producing polyurethane moldings as claimed in claim 1, substantially comprising
A) 0.5% to 40% by weight of at least one agent having release activity, selected from the group consisting of soaps, oils, waxes, and silicones and
B) 0.1% to 10% by weight of emulsifiers,
C) 0% to 5% by weight of foam stabilizers,
D) 0% to 5% by weight of viscosity modifiers,
E) 0% to 2% by weight of typical preservatives, bactericides, fungicides, and antioxidants,
F) 0.1% to 10% by weight of at least one bismuth carboxylate, and
G) water.

3. The dispersion as claimed in claim 1 or 2, wherein use is made as component F) of at least one Bi(III) salt of organic acids R—COOH, where R is an optionally branched C₈ to C₂₂ hydrocarbon radical optionally containing multiple bonds.

4. The dispersion as claimed in any of claims 1 to 3, wherein bismuth trioctoate and/or bismuth trineodecanoate are used.

5. The use of the release agent dispersion as claimed in claims 1 to 4 for producing polyurethane moldings.

6. The use of the release agent dispersion as claimed in claims 1 to 4 for improving the coverability of polyurethane moldings produced using it.
